(19) United States
(12) Patent Application Publication
(10) Pub. No.: US 2009/0246509 A1
(43) Pub. Date: Oct. 1, 2009

(54) OPTICAL LAMINATE FOR PLASMA DISPLAY

(75) Inventors: Kenichi MURAYAMA, Saitama (JP); Satoru Shoshi, Saitama (JP)

Correspondence Address: OBLON, SPIVAK, MCCLELLAND MAIER & NEUSTADT, P.C., 1940 DUKE STREET, ALEXANDRIA, VA, 22314, US

(73) Assignee: LINTEC CORPORATION, Tokyo (JP)

(21) Appl. No.: 12/411,015

(22) Filed: Mar. 25, 2009

(30) Foreign Application Priority Data
Mar. 28, 2008 (JP) 2008-086999
Mar. 16, 2009 (JP) 2009-062739

(51) Int. Cl. B32B 5/16; B32B 15/08

(52) U.S. Cl. 428/327; 428/463; 428/339

(57) ABSTRACT

Provided is an optical laminate for a plasma display in which a moire phenomenon can be prevented without disposing an anti-glare film and the like in order to decrease a thickness of an optical filter in a plasma display, improve a productivity of the optical filter and reduce a cost thereof.

The optical laminate used for an optical filter of a plasma display comprises an electromagnetic-wave shielding film having a metal mesh and a contrast enhancing film, wherein a light diffusion pressure-sensitive adhesive layer containing organic fine particles is disposed on a surface of at least one of the electromagnetic-wave shielding film and the contrast enhancing film.

### BACKGROUND OF THE INVENTION

1. Field of the Invention

The present invention relates to an optical laminate suitably used for an optical filter of a plasma display.

2. Description of the Related Art

A plasma display is a device in which molecules of sealed rare gas are excited by plasma discharge between electrodes to generate a UV ray and excite a fluorescent material by the UV ray generated and in which a light in a visible light region is emitted from the fluorescent material excited to thereby display images. Since light emission is carried out by making use of plasma discharge in the above plasma display, an unnecessary electromagnetic-wave having a frequency band of 30 to 130 MHz leaks to the outside, and therefore the electromagnetic-wave is requested to be inhibited from leaking to the utmost so that an adverse effect is not exerted on other instruments (for example, information processing devices and the like).

Disclosed in, for example, a patent document 1 is an electroconductive mesh film which is used for an optical filter of a plasma display and in which an electroconductive fiber mesh prepared by constituting electroconductive fibers into a mesh form or an electroconductive metal mesh produced by metal such as a copper foil and the like is formed.

Further, in an optical filter of a plasma display, a contrast enhancing film is used as well in order to enhance a contrast of a screen (refer to, for example, a patent document 2).

When a metal mesh is used as an electromagnetic-wave shielding means for an electromagnetic-wave shielding film in an optical filter of a plasma display, a moire phenomenon is brought about by mutual interference between a metal mesh and a contrast enhancing film, and therefore an anti-glare film has had to be further disposed in order to prevent the moire phenomenon. An anti-glare film having a surface subjected to antiglare treatment is used in order to prevent a moire phenomenon in, for example, a patent document 3.

However, if the anti-glare film is disposed, the number of the films to be stuck in order to form an optical filter is increased, and therefore the problems that the optical filter is increased in a cost and reduced in a productivity and that the optical filter is increased as well in a thickness have been involved therein.
Patent document 1: Japanese Patent Application Laid-Open No. 226732/2004
Patent document 2: Japanese Patent Application Laid-Open No. 272161/2007
Patent document 3: Japanese Patent Application Laid-Open No. 189867/2006

### SUMMARY OF THE INVENTION

The present invention has been made in order to solve the problems described above, and an object of the present invention is to provide an optical laminate for a plasma display in which a moire phenomenon can be prevented without disposing an anti-glare film and the like in order to decrease a thickness of an optical filter in a plasma display, improve a productivity of the optical filter and reduce a cost thereof.

Intensive researches repeated by the present inventors in order to solve the problems described above have resulted in finding that the above object can be solved by using a specific light diffusion pressure-sensitive adhesive layer. The present invention has been completed based on the above knowledge.

That is, the summary of the present invention resides in:
1. an optical laminate used for an optical filter of a plasma display, comprising an electromagnetic-wave shielding film having a metal mesh and a contrast enhancing film, wherein a light diffusion pressure-sensitive adhesive layer containing organic fine particles is disposed on a surface of at least one of the electromagnetic-wave shielding film and the contrast enhancing film,
2. the optical laminate for a plasma display according to the above item 1, wherein the light diffusion pressure-sensitive adhesive layer has a haze value of 5 to 60%,
3. the optical laminate for a plasma display according to the above item 1, wherein the light diffusion pressure-sensitive adhesive layer has a thickness of 1 to 100 μm,
4. the optical laminate for a plasma display according to any of the above item 1, wherein a pressure-sensitive adhesive composition constituting the light diffusion pressure-sensitive adhesive layer comprises (A) a (meth)acrylic ester base copolymer having a cross-linkable functional group in a molecule, (B) a cross-linking agent and (C) an organic fine particle in which a difference in a refractive index from that of the above (meth)acrylic ester base copolymer is 0.03 or more and which has an average particle diameter of 1 to 15 μm,
5. the optical laminate for a plasma display according to the above item 4, wherein the cross-linking agent of the component (B) is a polyisocyanate compound and/or a metal chelate compound,
6. the optical laminate for a plasma display according to the above item 4, wherein the pressure-sensitive adhesive composition contains 0.1 to 3.0 parts by mass of the organic fine particle of the component (C) based on 100 parts by mass of an adhesive resin containing the (meth)acrylic ester base copolymer of the component (A), and
7. the optical laminate for a plasma display according to any of the above item 4, wherein the organic fine particle of the component (C) comprises a styrene-divinylbenzene copolymer.

The present invention has made it possible to provide an optical laminate for a plasma display which can prevent a moire phenomenon without disposing an anti-glare film and the like. This has made it possible to decrease a thickness of an optical filter in a plasma display, enhance the productivity and reduce the cost. In particular, a commercial value of the plasma display has been enhanced more by decreasing a thickness of the optical filter.

### BRIEF DESCRIPTION OF THE DRAWINGS

FIG. 1 is a cross-sectional schematic drawing showing one example of the optical laminate for a plasma display according to the present invention.

FIG. 2 is a cross-sectional schematic drawing showing another example of the optical laminate for a plasma display according to the present invention.

FIG. 3 is a cross-sectional schematic drawing showing another example of the optical laminate for a plasma display according to the present invention.

FIG. 4 is a cross-sectional schematic drawing showing one example of the optical laminate for a plasma display according to the comparative example.

FIG. 5 is a cross-sectional schematic drawing showing a contrast enhancing film used for the optical laminate for a plasma display according to the present invention.

### EXPLANATIONS OF THE CODES

1 Optical laminate of the present invention
2 Contrast enhancing film
3 Light diffusion pressure-sensitive adhesive layer containing organic fine particles
4 Electromagnetic-wave shielding film having a metal mesh
5 Adhesive layer
6 Anti-glare film
10 Optical laminate according to the comparative example
21 Lens part
22 Light absorbing part

### BEST MODE FOR CARRYING OUT THE INVENTION

The optical laminate for a plasma display according to the present invention is an optical laminate comprising an electromagnetic-wave shielding film having a metal mesh and a contrast enhancing film, and it is used for an optical filter of a plasma display. It is characterized by that a light diffusion pressure-sensitive adhesive layer containing organic fine particles is disposed on a surface of at least one of the electromagnetic-wave shielding film and the contrast enhancing film each described above.

The structure of the optical laminate for a plasma display according to the present invention shall be explained with reference to drawings.

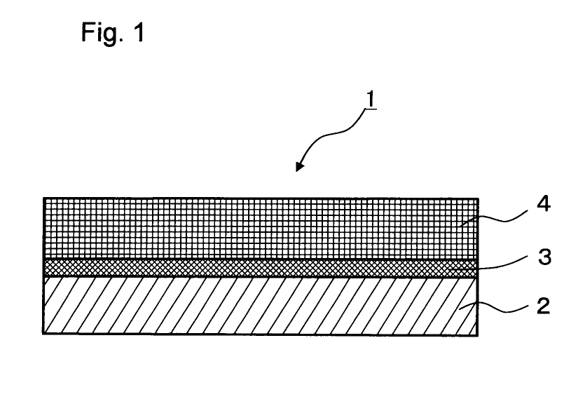

FIG. 1 is a cross-sectional schematic drawing showing one example of the optical laminate for a plasma display according to the present invention (hereinafter referred to as “the optical laminate of the present invention”).

As shown in FIG. 1, in the first example of the optical laminate 1 of the present invention, a light diffusion pressure-sensitive adhesive layer containing organic fine particles 3 (hereinafter referred to merely as “LDPSA layer”) is laminated on a surface of a contrast enhancing film 2, and an electromagnetic-wave shielding film having a metal mesh 4 (hereinafter referred to merely as “the electromagnetic-wave shielding film”) is laminated on a surface there.

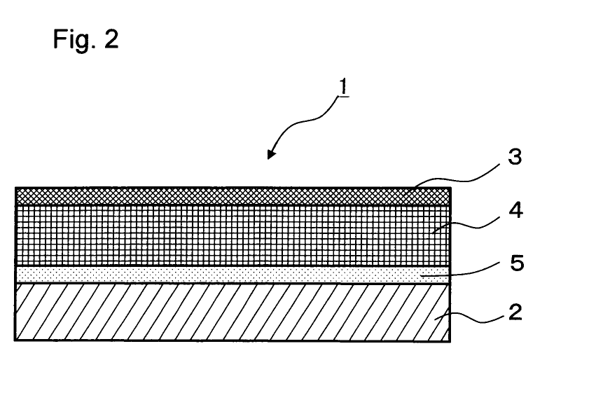

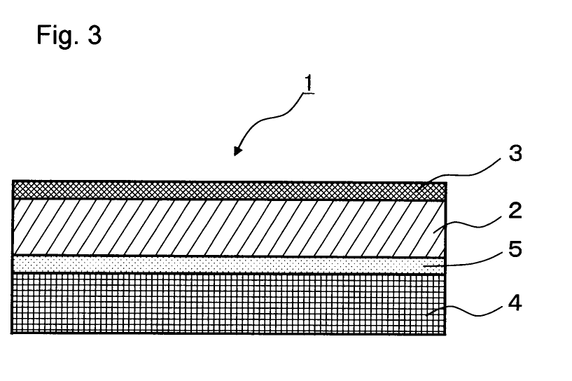

FIG. 2 and 3 are cross-sectional schematic drawings showing other examples of the optical laminates for a plasma display according to the present invention. In the second example of the optical laminate 1 of the present invention shown in FIG. 2, the electromagnetic-wave shielding film having a metal mesh 4 is laminated on the contrast enhancing film 2 via a bonding layer 5 laminated if desired, and the LDPSA layer 3 is laminated on a surface thereof.

Further, in the third example of the optical laminate 1 of the present invention shown in FIG. 3, the contrast enhancing film 2 is laminated on the electromagnetic-wave shielding film 4 having a metal mesh via the bonding layer 5 laminated if desired, and the LDPSA layer 3 is laminated thereon. That is, in the present invention, the LDPSA layer 3 may be disposed on a surface of at least one of the contrast enhancing film 2 and the electromagnetic-wave shielding film 4, and a site on which they are disposed is not restricted. From the viewpoint of decreasing a thickness of the optical filter, the LDPSA layer 3 is preferably disposed in place of the bonding layer which is disposed in order to adhere the base material of the optical filter and various films.

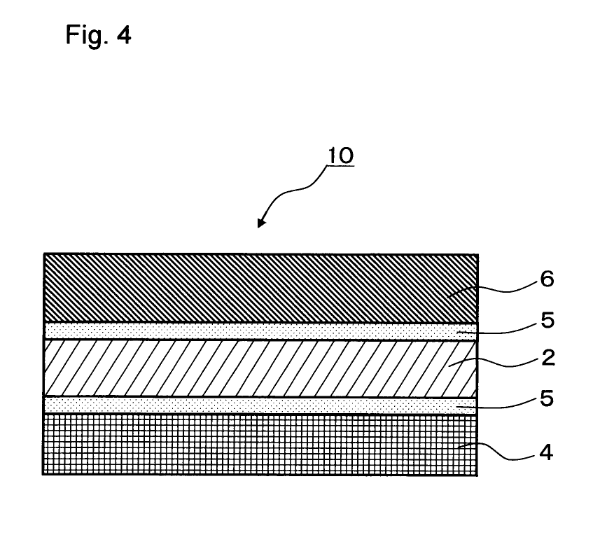

On the other hand, FIG. 4 is a cross-sectional schematic drawing showing one example of an optical laminate 10 according to the comparative example. In the optical laminate 10 according to the comparative example shown in FIG. 4, a contrast enhancing film 2 is laminated on an electromagnetic-wave shielding film 4 via a bonding layer 5 laminated if desired, and an anti-glare film 6 is laminated thereon via the bonding layer 5 laminated if desired. Since the number of the films laminated is increased by laminating the anti-glare film 6, the optical filter is reduced in a productivity, and it is increased in a thickness, so that it is not consistent with a social demand of reducing a thickness of a plasma display.

The LDPSA layer 3 according to the present invention has a haze value of preferably 5 to 60%, more preferably 15 to 25%. If it is 5% or more, light can be diffused to such an extent that a moire phenomenon can be improved, and if it is 60% or less, it is preferred from the viewpoint that light transmission necessary for use in a filter of a plasma display is secured.

Further, LDPSA layer has a thickness of preferably 1 to 100 μm, more preferably 5 to 60 μm. If it is 1 μm or more, the sufficiently high light diffusion effect and adhesive strength are obtained, and if it is 100 μm or less, the pressure-sensitive adhesive composition can suitably be prevented from protruding or bleeding from an end part of the optical filter.

The contrast enhancing film 2 according to the present invention is used for a purpose of providing the optical filter with a contrast enhancing function. The contrast enhancing film 2 includes, for example, a film having a lens part and a light absorbing part as described in the patent document 2.

The light absorbing part includes a part in which wedge-shaped cross-sectional forms are extended to, for example, a horizontal direction in a plane of the contrast enhancing film 2 and in which a large number of them is arranged parallel at a pitch of, for example, 100 μm in a direction vertical to a horizontal direction.

The light absorbing part is filled with, for example, a material obtained by adding light absorbing particles to a transparent binder resin.

On the other hand, used as a method for forming the lens part are, for example, publicly known methods such as a hot press method in which a heated die is pressed to a thermoplastic resin, a casting method in which a thermoplastic resin composition is injected into a die and solidified, an injection molding method and a UV method in which a UV ray-curable type resin composition is injected into a mold and cured by a UV ray. Among the above methods, the UV method which is excellent in a mass productivity is more preferred. The UV method makes it possible to produce a lens unit using a roll-shaped die by continuously embossing while supplying continuously a sheet. For example, the lens part is constituted usually from a material such as epoxy acrylate having an ionizing radiation-curable property. The ionizing radiation is preferably a UV ray, an electron beam and the like.

The lens part is formed in the manner described above, and at the same time, wedge-shaped grooves are formed. The above wedge-shaped grooves are filled with an ink containing light absorbing particles and a transparent binder resin working a function of a binder resin, and it is cured, whereby a light absorbing part is formed. The light absorbing particle has a light absorbing action, and therefore light which is incident into an inside of the light absorbing part is absorbed by the above light absorbing particle and does not come out to an outside of the light absorbing part.

Materials such as resins having an ionizing radiation-curable property are preferably used as a material used for the transparent binder resin of the light absorbing part. Commercially available colored particles can be used as the light absorbing particles constituting the light absorbing part, and they are dispersed in the transparent binder resin as a binder resin to prepare an ink.

In order to enhance easiness in the production, additives such as a defoaming agent, a leveling agent and the like may be suitably added, if necessary, to the ink described above in small amounts.

Used as the colored particles are black pigments such as carbon black and the like and particles obtained by coloring transparent particles of acryl and the like by the black pigments such as carbon black and the like described above. Further, allowed to be used are materials substantially turned into a black color by mixing and dispersing the black coloring materials described above in mixtures of various pigments and/or dyes of blue, purple, yellow and red colors other than the black pigments or blue, purple, yellow and red color materials. Copper phthalocyanine and the like are used as the blue pigments; dioxazine violet and the like are used as the purple pigments; disazo yellow and the like are used as the yellow pigments; and chromophthal red type1 and the like are used as the red pigments. However, they shall not be restricted to the above compounds, and they may not be the pigments and may be the dyes. Further, they may be colored particles obtained by coloring transparent particles of acryl and the like by color pigments or dyes obtained by mixing and dispersing blue, purple, yellow, red and black pigments or dyes.

Among the colored particles described above, the black particles are preferred since they have the highest light absorbing property.

The light absorbing particles in the contrast enhancing film 2 according to the present invention have an average particle diameter of 1 μm or more, and it is preferably a half or less of a width of an upper base of the light absorbing part. If a size of the light absorbing particles is too small, the sufficiently high light absorbing effect can not be obtained. On the other hand, if a size of the light absorbing particles is so too large as exceeding a half of a width of an upper base of the light absorbing part, the ink is less liable to be filled in the wedge-shaped grooves in production to deteriorate a filling rate, and dispersion is brought about in the filling rate among the wedge-shaped groove units to generate optical unevenness, so that it is not preferred.

Further, the light absorbing particles in the contrast enhancing film 2 according to the present invention account preferably for 10 to 50% by volume based on the whole volume of the light absorbing part. Maintaining the above rate makes it possible to provide the easy production conditions while holding the sufficiently high light absorbing effect.

Used as the binder resin are, for example, UV ray-curable type resins and electron beam-curable type resins which are transparent resins having a prescribed refractive index and which have an ionizing radiation-curable function. Some of them are subjected directly to curing reaction, but they are subjected usually to curing reaction via a substance called a catalyst or an initiator which induces reaction. In order to cause curing reaction by a UV ray having a wavelength of 300 to 400 nm, several % of a substance called a photoinitiator which induces reaction in a UV ray region is usually mixed. Photoinitiators of a ketone base and an acetophenone base are available as the photoinitiator, and Sundray 1000, Darocure 1163, Darocure 1173, Irgacure 183, Irgacure 184, Irgacure 651 and the like are known. It can suitably be selected according to the kind (wavelength characteristic) of an ionizing radiation for curing. Suitably selected as the ionizing radiation-curable type resins are reactive oligomers (an epoxy acrylate base (for example, ethylene oxide-modified bisphenol A diacrylate and the like), a urethane acrylate base, a polyether acrylate base, a polyester acrylate base, a polythiol base and the like) and reactive monomers (vinylpyrrolidone, 2-ethylhexyl acrylate, 2-hydroxyethyl acrylate, tetrahydrofurfuryl acrylate, p-cumylphenoxyethyl acrylate and the like). The kind of the reactive oligomers and a composition ratio of the reactive monomers having a low viscosity and a low molecular weight can suitably be changed in order to control a fluidity of an ionizing radiation-curable type light absorbing material before curing. In addition thereto, an adhesive property improving agent is suitably added if desired. The adhesive property improving agent includes, for example, 2-acryloyloxyethylsuccinic acid and the like.

The materials suitably selected from those described above are evenly dispersed (mixed) by a three roll dispersing method and the like to prepare an ink. An ink composition ratio thereof can suitably be determined evaluating the curable property by an ionizing radiation and various physical properties after curing, and it comprises preferably 10 to 50% by mass of the coloring agent, 50 to 90% by mass of the binder resin and 1 to 10% by mass of the photoinitiator based on the ink solid matter. The ink is filled in the wedge-shaped grooves by a method such as a wiping method and the like and then cured and fixed by an ionizing radiation such as a UV ray and the like.

In the contrast enhancing film 2 according to the present invention, the wedge-shaped grooves having a form in which black stripes are provided on a lower base of the grooves described above can be used as well. An outside light which is incident from an observer side into the black stripes is absorbed by the black stripes to further enhance the contrast.

When the optical filter for a plasma display having the contrast enhancing film 2 described above which is disposed in the plasma display is used, the plasma display is less liable to be reduced in a contrast even under environment in which an outside light strikes on the display surface.

Next, the electromagnetic-wave shielding film 4 according to the present invention shall be explained. The electromagnetic-wave shielding film 4 according to the present invention is, as described in, for example, Japanese Patent Application Laid-Open No. 246879/2007, preferably a laminated film having a mesh-shaped metal foil formed on a surface of a boning agent layer provided on one surface of a transparent film. Capable of being used as the transparent film are films of an acryl resin, a polycarbonate resin, a polypropylene resin, a polyethylene resin, a polystyrene resin, a polyester resin, a cellulose base resin, a polysulfone resin, a polyvinyl chloride resin and the like. Usually, the film of a polyester resin such as a polyethylene terephthalate resin and the like which are excellent in a mechanical strength and have a high transparency is preferably used. A thickness of the transparent film shall not specifically be restricted, and it is preferably 50 to 200 μm from the viewpoints of having a mechanical strength and increasing resistance against bending.

A method for forming the metal mesh of the electromagnetic-wave shielding film 4 includes, for example, a method in which a metal foil is provided on one surface of a transparent film via a boning agent to carry out etching treatment. Capable of being used as the metal foil are foils of metals such as copper, iron, nickel, chromium and the like or alloys of the above metals and alloys comprising at least one of the above metals as a principal component. It shall not specifically be restricted, and among them, a copper foil is preferably used since it has a high electromagnetic-wave shielding property, is readily subjected to etching and liable to be handled.

A thickness of the metal foil is preferably 1 to 100 μm, more preferably 5 to 20 μm. If a thickness of the metal foil is less than 1 μm, the electromagnetic-wave shielding property is not satisfactory, and if it exceeds 100 μm, progress of side etching can not be neglected, so that it is difficult to form an apertural part at a prescribed accuracy by etching.

Also, the metal foil may be provided with a blackened layer on a transparent film side by blackening treatment, and it can be endowed with an antireflection property in addition to a rust preventive effect. Chromate treatment may be provided as rust preventing treatment on the blackened layer. When a metal foil which is subjected in advance to blackening treatment is not used, blackening treatment can be carried out as well in a suitable subsequent step. The blackened layer can be formed as well by forming a light-sensitive resin layer which can be a resist layer by using a composition colored to a black color and allowing the resist layer to remain without removing it after finishing etching, or it can be formed as well by a plating method in which a coating film of a black color base is provided.

Further, other methods for forming the metal mesh of the electromagnetic-wave shielding film 4 include, for example, a method in which an electroconductive ink is printed on a transparent film in a pattern form and in which metal is plated on the above electroconductive ink layer (refer to, for example, Japanese Patent Application Laid-Open No. 13088/2000), a method in which a paste containing palladium colloid is printed on a near infrared ray shielding layer by using a screen mask having patterns of a prescribed lattice form (mesh form) and in which this is dipped in an electroless copper plating liquid and subjected to electroless copper plating, followed by subjecting it to electrolytic copper plating and then further to electrolytic plating of Ni—Sn alloy (refer to, for example, Japanese Patent Application Laid-Open No. 096049/2007), a method in which a transparent film and a metal foil are laminated with an adhesive and in which the metal foil is then turned into a mesh form by a photolithography method (refer to, for example, Japanese Patent Application Laid-Open No. 145678/1999), a method in which prepared is a transparent film obtained by forming an electroconductive treatment layer on one surface of a transparent film and forming thereon a metal layer as a metal-plated layer by electrolytic plating and in which the metal-plated layer and the electroconductive treatment layer of the above transparent film subjected to metal plating are turned into a mesh form by a photolithography method (refer to, for example, Japanese Patent Application Laid-Open No. 86991/2003) and the like.

When a film of a thermally fusible resin such as an ethylene-vinyl acetate copolymer resin and an ionomer resin each having a high thermally fusing property is used alone or in the form of a laminate with other resin films, the transparent film and the metal foil can be laminated without providing a boning agent layer, but they are laminated usually by a dry laminate method and the like using a boning agent layer. A boning agent constituting the boning agent layer includes a boning agent such as acryl resins, polyester resins, polyurethane resins, polyvinyl alcohol resins, vinyl chloride/vinyl acetate copolymer resins, ethylene-vinyl acetate copolymer resins and the like. In addition to them, thermosetting resins and ionizing radiation-curable resins (UV ray-curable resins, electron beam-curable resins and the like) can be used as well.

The pressure-sensitive adhesive composition constituting the light diffusion pressure-sensitive adhesive (LDPSA ) layer 3 in the optical laminate 1 of the present invention comprises preferably (A) a (meth)acrylic ester base copolymer having a cross-linkable functional group in a molecule, (B) a cross-linking agent and (C) an organic fine particle in which a difference in a refractive index from that of the above (meth)acrylic ester base copolymer is 0.03 or more and which has an average particle diameter of 1 to 15 μm.

Copolymers of (meth)acrylic esters in which an alkyl group of an ester part has 1 to 20 carbon atoms, monomers having a cross-linkable functional group in a molecule and other monomers used if desired can preferably be given as the (meth)acrylic ester base copolymer having a cross-linkable functional group in a molecule which is the component (A) used for the pressure-sensitive adhesive composition constituting the LDPSA layer 3 according to the present invention.

In this respect, the examples of the (meth)acrylic esters in which an alkyl group of an ester part has 1 to 20 carbon atoms include methyl (meth)acrylate, ethyl (meth)acrylate, propyl (meth)acrylate, n-butyl (meth)acrylate, t-butyl (meth)acrylate, pentyl (meth)acrylate, hexyl (meth)acrylate, cyclohexyl (meth)acrylate, 2-ethylhexyl (meth)acrylate, isooctyl (meth)acrylate, decyl (meth)acrylate, dodecyl (meth)acrylate, myristyl (meth)acrylate, palmityl (meth)acrylate, stearyl (meth)acrylate and the like. They may be used alone or in combination of two or more kinds thereof. (Meth)acrylic acid includes both of acrylic acid and methacrylic acid.

Further, the monomers having a cross-linkable functional group in a molecule contain preferably at least one of a hydroxy group, a carboxy group, an amino group and an amide group as a functional group, and the specific examples thereof include (meth)acrylic acid hydroxyalkyl esters such as 2-hydroxyethyl (meth)acrylate, 2-hydroxypropyl (meth)acrylate, 3-hydroxypropyl (meth)acrylate, 2-hydroxybutyl (meth)acrylate, 3-hydroxybutyl (meth)acrylate, 4-hydroxybutyl (meth)acrylate and the like; acrylamides such as (meth)acrylamide, N-methyl(meth)acrylamide, N-methylol(meth)acrylamide and the like; (meth)acrylic acid monoalkylamino esters such as monomethylaminoethyl (meth)acrylate, monoethylaminoethyl (meth)acrylate, monomethylaminopropyl (meth)acrylate, monoethylaminopropyl (meth)acrylate and the like; and ethylenically unsaturated carboxylic acids such as acrylic acid, methacrylic acid, crotonic acid, maleic acid, itaconic acid, citraconic acid and the like. The above monomers may be used alone or in combination of two or more kinds thereof.

The other monomers used if desired shall not specifically be restricted as long as they are compounds copolymerizable with the monomers having a cross-linkable functional group in a molecule. They include, for example, at least one of styrene base monomers such as styrene, α-methylstyrene, vinyltoluene, vinyl benzoate and the like; nitrile base monomers such as acrylonitrile, methacrylonitrile and the like; diene base monomers such butadiene, isoprene and the like; vinyl ether base monomers such as vinylbenzyl methyl ether, vinyl glycidyl ether and the like; 1-vinyl-2-pyrrolidone; and the like.

The (meth)acrylic ester base copolymer which is used as the component (A) shall not specifically be restricted in a copolymerization form thereof, and it may be any of random, block and graft copolymers. A molecular weight thereof is preferably 500,000 or more in terms of a weight average molecular weight. If the weight average molecular weight is 500,000 or more, an adhesiveness with the adherent and an adhesion durability thereof are sufficiently high, and lifting and peeling are less liable to be brought about. Considering the adhesiveness and the adhesion durability, the weight average molecular weight is preferably 600,000 to 2,200,000, particularly preferably 700,000 to 2,000,000.

The weight average molecular weight described above is a value reduced to polystyrene which is measured by a gel permeation chromatography (GPC) method.

Further, in the above (meth)acrylic ester base copolymer having a cross-linkable functional group in a molecule, a content of the monomer unit having a cross-linkable functional group in a molecule falls preferably in a range of 0.01 to 10% by mass based on the (meth)acrylic ester base copolymer. If the above content is 0.01% by mass or more, cross-linking is satisfactorily carried out by reaction with a cross-linking agent described hereinafter, and the durability is improved. On the other hand, if it is 10% by mass or less, a reduction in the sticking aptitude to the adherent due to the too high cross-linking degree is not caused, and therefore it is preferred. Considering the durability and the sticking aptitude to the adherent, a more preferred content of the monomer unit having a cross-linkable functional group in a molecule is 0.05 to 8.0% by mass, and it falls particularly preferably in a range of 0.2 to 8.0% by mass.

In the present invention, the above (meth)acrylic ester base copolymer of the component (A) may be used alone or in combination of two or more kinds thereof.

A method for polymerizing a polymerizable monomer comprising the (meth)acrylic ester in which an alkyl group of an ester part has 1 to 20 carbon atoms, the monomer having a cross-linkable functional group in a molecule and the other monomer used if desired shall not specifically be restricted, and an anion polymerization method, a cation polymerization method and a radical polymerization method are given. Among them, the radical polymerization method is preferred since the targeted (meth)acrylic ester base copolymer of the component (A) having a cross-linkable functional group in a molecule can be obtained at a good yield by easy operation.

A specific method for polymerizing the polymerizable monomer described above by the radical polymerization method to obtain the targeted (meth)acrylic ester base copolymer having a cross-linkable functional group in a molecule includes, for example, a method in which the polymerizable monomer and the radical polymerization initiator are added to a solvent and stirred at 60 to 120° C. for 8 to 24 hours in a reactor for polymerization.

The radical polymerization initiator described above shall not specifically be restricted and includes, for example, peroxides such as hydrogen peroxide, isobutyl peroxide, t-butyl peroxide, octanoyl peroxide, decanoyl peroxide, lauroyl peroxide, benzoyl peroxide, potassium persulfate, ammonium persulfate, sodium persulfate and the like; azo compounds such as azobisisobutyronitrile, 2,2′-azobis(4-methoxy-2,4-dimethylvaleronitrile), 2,2′-azobis(2-cyclopropylpropionitrile), 2,2′-azobis(2-methylpropionitrile), 2,2′-azobis(2-methylbutyronitrile) and the like; redox initiators such as hydrogen peroxide-ascorbic acid, hydrogen peroxide-ferrous chloride, persulfate-sodium hydrogensulfite and the like. Among the radical polymerization initiators described above, the azo compounds such as azobisisobutyronitrile and the like are preferred.

An addition amount of the radical polymerization initiator is usually 0.05 to 1 part by mass, preferably 0.1 to 0.8 part by mass based on 100 parts by mass of the polymerizable monomer used.

The solvent used for polymerizing the polymerizable monomer shall not specifically be restricted as long as it does not disturb the polymerization reaction. It includes, for example, esters such as methyl acetate, ethyl acetate, propyl acetate, butyl acetate, methyl lactate and the like; ketones such as acetone, methyl ethyl ketone, methyl isobutyl ketone, diethyl ketone, cyclohexanone and the like; ethers such as diethyl ether, diisopropyl ether, dibutyl ether, 1,2-dimethoxyethane, tetrahydrofuran, 1,4-dioxane and the like; amides such as N,N′-dimethylformamide, N,N′-dimethylacetamide, hexamethylphosphoric acid phosphoroamide, N-methylpyrrolidone and the like; lactams such as ε-caprolactam and the like; lactones such as γ-lactone, δ-lactone and the like; sulfoxides such as dimethyl sulfoxide, diethyl sulfoxide and the like; aliphatic hydrocarbons such as pentane, hexane, heptane, octane, nonane, decane and the like; alicyclic hydrocarbons such as cyclopentane, cyclohexane, cyclooctane and the like; aromatic hydrocarbons such as benzene, toluene, xylene and the like; halogenated hydrocarbons such as dichloromethane, chloroform, carbon tetrachloride, 1,2-dichloroethane, chlorobenzene; mixed solvents comprising two or more kinds of them; and the like. Among them, the esters, the ketones, the aromatic hydrocarbons and the mixed solvents comprising two or more kinds of them are preferably used.

A use amount of the polymerizable monomer falls preferably in a range of 1 to 60% by mass based on the total amount of the polymerizable monomer and the solvent.

In the pressure-sensitive adhesive composition constituting the LDPSA layer 3 according to the present invention, a tackifier may be blended, if desired, in addition to the (meth)acrylic ester base copolymer having a cross-linkable functional group in a molecule which is the component (A). The tackifier shall not specifically be restricted, and those suitably selected from compounds which have so far conventionally been used as tackifiers in pressure-sensitive adhesives can be used. The tackifier includes rosin base resins (crude rosin, hydrogenated rosin and rosin esters), xylene resins, terpene-phenol resins, petroleum resins, coumarone indene resins, terpene resins, styrene resins, ethylene-vinyl acetate resins and elastomers such as styrene-butadiene block polymers, styrene-isoprene block polymers, ethylene-isoprene-styrene block polymers, vinyl chloride/vinyl acetate base polymers, acryl base rubbers and the like.

The specific examples of commercially available products of the tackifiers described above include rosin esters such as Pine Crystal KE-359 (manufactured by Arakawa Chemical Industries Ltd.), Super Ester A-75 (manufactured by Arakawa Chemical Industries Ltd.), Super Ester A-100 (manufactured by Arakawa Chemical Industries Ltd.), Super Ester A-125 (manufactured by Arakawa Chemical Industries Ltd.) and the like, polymerized rosin esters such as Pensel D125 (manufactured by Arakawa Chemical Industries Ltd.), Pensel D160 (manufactured by Arakawa Chemical Industries Ltd.), Rikatac PCJ (manufactured by Rika Fine Tech Co., Ltd.) and the like, xylene resins such as Nikanol HP-100 (manufactured by Mitsubishi Gas Chemical Company, Inc.), Nikanol HP-150 (manufactured by Mitsubishi Gas Chemical Company, Inc.), Nikanol H-80 and the like, terpene-phenol resins such as YS Polyster T-115 (manufactured by Yasuhara Chemical Co., Ltd.), Mytec G125 (manufactured by Yasuhara Chemical Co., Ltd.) and the like, petroleum resins such as FTR-6120 (manufactured by Mitsui Chemicals, Inc.), FTR-6100 (manufactured by Mitsui Chemicals, Inc.) and the like.

The above tackifiers may be used alone or in combination of two or more kinds thereof, and among them, the rosin esters are suited from the viewpoint of a tackifying effect and the like.

A content of the tackifier added, if desired, to the pressure-sensitive adhesive composition of the present invention is not restricted and can suitably be controlled in order to obtain a desired adhesion. The content of tackifier falls in a range of preferably 0 to 100% by mass (solid content), more preferably 0 to 50% by mass (solid content) based on the total amount of the tackifier and the (meth)acrylic ester base copolymer.

Next, the cross-linking agent which is the component (B) contained in the pressure-sensitive adhesive composition constituting the LDPSA layer 3 according to the present invention shall be explained. The cross-linking agent of the component (B) is preferably, for example, a polyisocyanate compound, a metal chelate compound, a polyepoxy compound, a polyimine compound, a melamine resin, a urea resin, dialdehydes, a methylol polymer, an aziridine base compound, metal alkoxide, a metal salt and the like, and it is preferably the polyisocyanate compound and/or the metal chelate compound.

In this respect, capable of being given as the polyisocyanate compound are aromatic polyisocyanates such as 2,4-tolylenediisoycanate, 2,6-tolylenediisoycanate, 1,3-xylylenediisoycanate, 1,4-xylylenediisoycanate and the like, aliphatic polyisocyanates such as hexamethylenediisoycanate, and the like, alicyclic polyisocyanates such as isophoronediisoycanate, hydrogenated diphenylmethanediisocyanate and the like, biuret bodies thereof, isocyanurate bodies thereof and adducts (for example, xylylenediisocyanate base trifunctional adducts) which are reaction products with low molecular active hydrogen-containing compounds such as ethylene glycol, propylene glycol, neopentyl glycol, trimethylolpropane, castor oil and the like.

Further, the metal chelate compound includes coordinate compounds of multivalent metals such as trisethylacetoacetatealuminum, ethylacetoacetatealuminum diisopropylate, trisacetylacetonatealuminum and the like.

The polyepoxy compound includes bisphenol A type epoxy compounds, bisphenol F type epoxy compounds, 1,3-bis(N,N-diglycidylaminomethyl)benzene, 1,3-bis(N,N-diglycidylaminomethyl)toluene, N,N,N′,N′-tetraglycidyl-4,4′-diaminodiphenylmethane and the like.

The polyimine compound includes N,N′-diphenylmethane-4,4′-bis(l-aziridinecarboxyamide), trimethylolpropane-tri-β-aziridinyl propionate, tetramethylolmethane-tri-ε-aziridinyl propionate, N,N′-toluene-2,4-bis(l-aziridinecarboxyamide)-triethylenemelamine and the like.

In the present invention, the cross-linking agents described above may be used alone or in combination of two or more kinds thereof. A use amount thereof is selected in a range of usually 0.01 to 20 parts by mass, preferably 0.1 to 10 parts by mass based on 100 parts by mass of the (meth)acrylic ester base copolymer having a cross-linkable functional group in a molecule which is the component (A).

In the organic fine particle which is the component (C) contained in the pressure-sensitive adhesive composition constituting the LDPSA layer 3 according to the present invention, a difference in a refractive index from that of the (meth)acrylic ester base copolymer of the component (A) is 0.03 or more, preferably 0.05 or more and more preferably 0.07 or more. If a difference in the refractive index is less than 0.03, the light diffusion effect is reduced, and it is difficult to prevent a moire phenomenon. In this connection, a difference in a refractive index between the (meth)acrylic ester base copolymer and the organic fine particle is preferably 0.2 or less.

Further, a difference in a specific gravity between the organic fine particle which is the component (C) and the (meth)acrylic ester base copolymer of the component (A) is preferably less than 0.5, more preferably less than 0.3 and particularly preferably less than 0.2. A difference in the specific gravity described above may be 0. Reducing a difference in the specific gravity described above makes it possible to uniformize a dispersion state of the organic fine particle in the pressure-sensitive adhesive composition, and as a result thereof, the pressure-sensitive adhesive composition for a plasma display which exerts an excellent effect for preventing a moire phenomenon can be obtained.

In addition thereto, the organic fine particle which is the component (C) is preferably a monodispersed fine particle. The monodispersed fine particles can evenly diffuse light.

Further, the organic fine particle which is the component (C) has an average particle diameter of preferably 1 to 15 μm, more preferably 2 to 10 μm and particularly preferably 3 to 5 μm. If the average particle diameter is less than 1 μm, the organic fine particles may cause secondary coagulation in a certain case, and if it exceeds 15 μm, the sufficiently high adhesion may not be obtained in sticking in a certain case.

The average particle diameter is a value measure by a centrifugal settling penetration method. A centrifugal automatic particle size distribution measuring instrument (trade name “CAPA-700” manufactured by HORIBA, Ltd.) is used for measurement, wherein a liquid comprising 1.2 g of the organic fine particles and 98.8 g of isopropyl alcohol is sufficiently stirred to prepare a sample for measurement.

A content of the organic fine particle which is the component (C) falls in a range of preferably 0.1 to 3.0 parts by mass, more preferably 0.1 to 2.0 parts by mass based on 100 parts by mass of the sticky resin component comprising the (meth)acrylic ester base copolymer of the component (A) and the tackifier added if desired. If it is 0.1 part by mass or more, the effect of preventing a moire phenomenon can be provided, and if it is 3.0 parts by mass or less, the total luminous transmittance is not reduced, so that it is preferred.

Capable of being used as the organic fine particle of the component (C) are, for example, polyolefin base resin particles such as polyethylene particles, polypropylene particles and the like and other polymeric particles such as styrene-divinylbenzene copolymer particles, polystyrene particles, acryl base resin particles and the like, and it may be cross-linked polymer particles, for example, cross-linked styrene-divinylbenzene copolymer particles, cross-linked acryl base resin particles and the like. Further, capable of being used as well are particles comprising copolymers obtained by copolymerizing two or more kinds selected from ethylene, propylene, styrene, methyl methacrylate, benzoguanamine, formaldehyde, melamine, butadiene and the like.

Among the organic fine particle of the component (C), the styrene-divinylbenzene copolymer particles (including the cross-linked styrene-divinylbenzene copolymer particles) are preferred since they have a high transparency and provide a good light diffusion property.

The styrene-divinylbenzene copolymer particles are commercially available, and a trade name “SX-350H” and the like manufactured by Soken Chemical & Engineering Co., Ltd. are suitably used.

The pressure-sensitive adhesive composition constituting the LDPSA layer 3 according to the present invention may contain, if desired, various additives such as a UV absorber, a light stabilizing agent, an antioxidant and the like.

The pressure-sensitive adhesive composition according to the present invention is coated, after the blending matters such as the component (A), the component (B), the component (C) and the like each described above are mixed and stirred, on a surface of the contrast enhancing film 2 in a desired thickness by means of a publicly known coating device such as a knife coater, a roll knife coater, a reverse roll coater, a gravure coater, a die coater and the like and dried, and then the electromagnetic-wave shielding film 4 is laminated thereon, or it is coated on a surface of the electromagnetic-wave shielding film 4 in a desired thickness and dried, and then the contrast enhancing film 2 is laminated thereon, whereby the optical laminate 1 shown in FIG. 1 is obtained.

The optical laminate 1 shown in FIG. 2 or 3 can be obtained as well by coating the pressure-sensitive adhesive composition described above on a surface of the contrast enhancing film 2 or the electromagnetic-wave shielding film 4.

The pressure-sensitive adhesive composition according to the present invention may be coated, as described above, directly on the contrast enhancing film 2, the electromagnetic-wave shielding film 4 or the like, or the above adhesive composition may be coated in advance on a support or a release sheet in a desired thickness to thereby form the LDPSA layer 3 formed in a sheet form, and then it may be laminated on the contrast enhancing film 2, the electromagnetic-wave shielding film 4 or the like.

The support used when obtaining the LDPSA layer 3 formed in a sheet form shall not specifically be restricted, and used are, for example, sheet-shaped plastic materials used for various optical parts, such as polyvinyl alcohol, triacetyl cellulose, polymethyl methacrylate, polycarbonate, polysulfone base resins, polynorbornene base resins and the like, and in addition thereto, used are resin films of polyethylene, polypropylene, polyethylene terephthalate, polyvinyl chloride, ethylene-vinyl acetate copolymers, polyurethane, polystyrene, polyimide and the like, papers such as wood free paper, coated paper, laminated paper and the like, metal foils, woven fabrics, nonwoven fabrics and laminates thereof. A thickness of the above support is usually 6 to 300 μm, preferably 12 to 200 μm.

In order to protect the pressure-sensitive adhesive composition, a release sheet is usually laminated on a surface reverse to a side on which the support for the LDPSA layer 3 formed in a sheet form according to the present is provided. Used as the release sheet is, for example, a material obtained by subjecting the sheet material selected from the supports described above to release-treatment with a silicone resin and the like. Further, the LDPSA layer 3 according to the present invention may assume a form in which the support described above is not used. In this case, the LDPSA layer 3 according to the present invention is used in a form in which both surfaces thereof are protected by the release sheets. A light peeling strength type release sheet and/or a heavy peeling strength type release sheet are suitably used, if desired, as the release sheet.

The bonding layer 5 used, if desired, in the optical laminate 1 of the present invention may be any ones as long as they have an adherence property and firmly adhere the films or the film and the transparent substrate. Used is, for example, a pressure-sensitive adhesive composition obtained by removing the organic fine particles from the pressure-sensitive adhesive composition used for the LDPSA layer 3.

A transparent substrate, a color correction filter, an antireflective filter, a near infrared ray absorbing filter, a neon light absorbing filter, a UV ray absorbing filter and the like are further laminated on the optical laminate 1 of the present invention obtained in the manner described above, whereby an optical filter is formed.

The constitution of the optical filter is obtained by laminating the contrast enhancing film 2 or the electromagnetic-wave shielding film 4 in the optical laminate 1 shown in FIG. 1 on a surface of the transparent substrate via the bonding layer 5 and laminating the color correction filter and the antireflective filter in this order on a surface of a reverse side of the transparent substrate, if desired, via the bonding layer 5. The antireflective filter is usually disposed on an outermost part to an audience viewing the plasma display. The color correction filter may be disposed between the antireflective filter and the transparent substrate or may be disposed between the optical laminate 1 and the transparent substrate or an inside (plasma display panel side) of the optical laminate 1.

The transparent substrate described above may be transparent in a visible wavelength region and includes inorganic compound-molded matters such as glass, quartz and the like and organic polymer-molded matters. Capable of being given as the organic polymer-molded matters are polyethylene terephthalate (PET), polysulfone, polyethersulfone (PES), polystyrene (PS), polyethylene naphthalate (PEN), polyarylate, polyetheretherketone (PEEK), polycarbonate (PC), polypropylene (PP), polyimide, triacetyl cellulose (TAC), polymethyl methacrylate (PMMA) and the like, but it shall not be restricted to the above products. Among them, polyethylene terephthalate (PET) is preferred from the viewpoints of a cost, a heat resistance and a transparency.

The color correction filter is provided for controlling a color of the optical filter in order to improve a color purity of emission from the plasma display panel, a color reproduction range, a display color in OFF of an electric power source and the like. It can be formed, for example, by producing a film from a composition prepared by dispersing a toning pigment in a binder resin or coating the above composition on the transparent substrate or other functional filters and, if necessary, passing through drying and curing treatments.

Pigments optionally selected from publicly known pigments having a maximum absorbing wavelength in 380 to 780 nm which is a visible region can be used in combination as the toning pigment for the color correction filter according to uses. Pigments described in Japanese Patent Application Laid-Open No. 275432/2000, Japanese Patent Application Laid-Open No. 188121/2001, Japanese Patent Application Laid-Open No. 350013/2001, Japanese Patent Application Laid-Open No. 131530/2002 and the like can suitably be used as the publicly known pigments which can be used as the toning pigment. Further, capable of being used in addition thereto are pigments of an anthraquinone base, a naphthalene base, an azo base, a phthalocyanine base, a pyrromethene base, a tetrazaporphyrin base, a squarylium base, a cyanine base and the like.

Resins such as polyester resins, polyurethane resins, acryl resins, epoxy resins and the like are used as the binder resin for the color correction filter. Also, capable of being applied as a method for drying and curing the binder resin are a drying and solidifying method carried out by drying a solvent (or a dispersant) from a solution (or an emulsion), a curing method making use of polymerization and cross-linking reaction carried out by energy of heat, a UV ray, an electron beam and the like and a curing method making use of reaction such as cross-linking and polymerization of a functional group such as a hydroxy group, an epoxy group and the like in the resin with an isocyanate group and the like in the curing agent.

Commercially available films (for example, trade name: No. 2832 manufactured by Toyobo Co., Ltd.) containing near infrared ray absorbing agents may be used as the near infrared ray absorbing filter, and films produced from compositions prepared by adding near infrared ray absorbing pigments to binder resins may be used as the near infrared ray absorbing filter, or the composition may be laminated on a transparent substrate by coating as the near infrared ray absorbing filter. When the optical filter is applied to a front surface of a plasma display panel, used is the optical filter which absorbs light in a near infrared region, that is, a wavelength region of 800 to 1100 nm which is generated originating in discharge of xenon gas emitted by the plasma display panel. The transmission factor of a near infrared ray in the above region is 20% or less, preferably 10% or less. In addition thereto, the near infrared ray absorbing filter has preferably a sufficiently high light transmission factor in a visible light region, that is, a wavelength region of 380 to 780 nm.

The near infrared ray absorbing pigment includes, to be specific, organic near infrared ray absorbing pigments such as polymethine base compounds, cyanine base compounds, phthalocyanine base compounds, naphthalocyanine base compounds, naphthoquinone base compounds, anthraquinone base compounds, dithiol base compounds, imonium base compounds, diimonium base compounds, aminium base compounds, pyrylium base compounds, serilium base compounds, squarylium base compounds, copper complexes, nickel complexes and dithiol base metal complexes and inorganic near infrared ray absorbing pigments such as tin oxide, indium oxide, magnesium oxide, titanium oxide, chromium oxide, zirconium oxide, nickel oxide, aluminum oxide, zinc oxide, iron oxide, antimony oxide, lead oxide, bismuth oxide, lanthanum oxide, cesium-containing tungsten oxide and the like, and they can be used alone or in combination of two more kinds thereof.

Further, the resins given in the color correction filter described above can be used as the binder resin.

The neon light absorbing filter is provided in order to absorb a neon light, that is, an emission spectrum of a neon atom radiated from the plasma display panel when the optical filter is used for the plasma display panel. A neon light has an emission spectrum zone in a wavelength of 550 to 640 nm, and therefore the neon light absorbing filter is preferably designed so that a spectral transmission factor thereof is 50% or less in a wavelength of 550 to 640 nm. The neon light absorbing filter can be formed by dispersing dyes which have so far been used as a pigment having maximum absorption at least in a wavelength region of 550 to 640 nm in the resin given for the color correction filter described above.

Cyanine base, oxonol base, methine base, subphthalocyanine base and porphyrin base pigments can be given as the specific examples of the above pigment.

The UV ray absorbing filter can be formed, for example, by dispersing a UV ray absorber in a binder resin. The UV ray absorber includes compounds comprising organic compounds such as benzotriazole, benzophenone and the like and inorganic compounds such as fine particle-shaped zinc oxide, cerium oxide and the like. The resins given in the color correction filter described above can be used as the above binder resin.

The antireflective (AR) filter assumes usually a multilayer structure in which a low refractive index layer and a high refractive index layer are laminated one after the other, and it can be formed by a dry method such as vapor deposition, sputtering and the like or by making use of a wet method such as coating and the like. Silicon oxide, magnesium fluoride, fluorine-containing resins and the like are used for the low refractive index layer, and titanium oxide, zinc sulfide, zirconium oxide, niobium oxide and the like are used for the high refractive index layer.

A protective film may be laminated, if necessary, in order to protect the surface of the optical filter or the surfaces of the respective layer in the optical filter from scratches and contamination. The protective film includes a hard coat layer (HC layer), an antifouling layer and the like.

### EXAMPLES

Next, the present invention shall be explained in further details with reference to examples, but the present invention shall by no means be restricted by the examples shown below.

A total luminous transmittance (%) and a moire test of the optical laminate, a haze value and a thickness of the light diffusion pressure-sensitive adhesive (LDPSA) layer, a refraction index of the organic fine particles and a refraction index of the (meth)acrylic ester base copolymer were evaluated according to the following methods.

### <Total Luminous Transmittance (%) of Optical Laminate>

A total luminous transmittances (%) of the optical laminates prepared in the following examples and comparative examples were measured according to JIS K 7105-1981 by means of an integral sphere type light transmission measuring device (brand name “NDH-2000”, manufactured by Nippon Denshoku Industries Co., Ltd.).

### <Moire Test of Optical Laminate>

Optical laminates prepared in the following examples and comparative examples were cut to a size of 233×309 mm by means of a cutting device (“Super Cutter PN1-600”, manufactured by Hagino Seiki Co., Ltd.), and the copper mesh film side was turned to a fluorescent lamp, and disposed at a distance of 30 cm from the fluorescent lamp, so that any moire on the other side of the optical laminates is visually confirmed.

Moire was measured by five monitors; a case in which all five monitors judged that the moire was not generated was marked with ⊚; a case in which four of five monitors judged that the moire was not generated was marked with ◯; a case in which one to three of five monitors judged that the moire was not generated was marked with Δ; and a case in which all five monitors judged that the moire was generated was marked with ×.

### <Haze Value of Light Diffusion Pressure-Sensitive Adhesive Layer>

Release films on both surfaces of the light diffusion pressure-sensitive adhesive (LDPSA) layers for the optical laminate which were obtained in the following examples and the comparative examples and in which both surfaces were covered with the release films were removed by peeling, and the diffuse transmittance (Hd (%)) and the total luminous transmittances (Ht (%)) were measured according to JIS K 7105-1981 by means of the integral sphere type light transmission measuring device (brand name “NDH-2000”, manufactured by Nippon Denshoku Industries Co., Ltd.) and calculated according to the following equation.

Haze value=(Hd/Ht)×100

### <Thickness of Diffusion Light Pressure-Sensitive Adhesive Layer>

Measured by means of a constant pressure thickness measuring device, a brand name “PG02” (diameter of a measuring probe: 5 mm) manufactured by Teclock Corporation. The measured value was calculated by peeling and removing the release films on both surfaces of the light diffusion pressure-sensitive adhesive (LDPSA) layers for the optical laminate which were obtained in the examples and the comparative examples and in which both surfaces were covered with the release films, superposing ten sheets thereof to measure a thickness thereof and dividing the thickness by ten.

### <Refraction Index of Organic Fine Particles>

A refraction index standard solution was dropped on the organic fine particles put on a slide glass, and a cover glass was put thereon to prepare a sample. The sample was observed under a microscope, and a refraction index of the refraction index standard solution at which it was most difficult to observe the outlines of the organic fine particles was set to a refraction index of the organic fine particles.

### <Refraction Index of (Meth)Acrylic Ester Base Copolymer>

Measured according to JIS K 7142-1996 by means of an Abbe's refractometer (Na light source, wavelength: 589 nm) manufactured by Atago Co., Ltd.

The following electromagnetic-wave shielding film and contrast enhancing film were used in Examples 1 to 3 and Comparative Example 1.

### 1. Electromagnetic-Wave Shielding Film

A polyethylene terephthalate film (“Cosmo Shine A4100” manufactured by Toyobo Co., Ltd.) having a thickness of 100 μm and a copper foil (trade name: BW-S, manufactured by Furukawa Circuit Foil Co., Ltd.)) subjected on one surface thereof to blackening treatment were prepared. A surface of a side reverse to a blackening-treated surface of the copper foil described above and the polyethylene terephthalate film described above were stuck with an bonding agent comprising a polyurethane resin (manufactured by Takeda Pharmaceutical Co., Ltd., mixed in a mass ratio of Takelac A310 (principal ingredient)/Takenate A10 (curing agent)/ethyl acetate=12/1/21) to prepare a laminate having a constitution of polyethylene terephthalate film/bonding agent layer/copper foil.

Next, a resist solution comprising casein as a principal component was coated on a copper foil side of the laminate obtained above and dried to form a light-sensitive resin layer. It was subjected to contact exposure by a UV ray using a mask having a pattern formed thereon and developed with water after exposure, and it was subjected to curing treatment and then baked at a temperature of 100° C. to form a resist pattern. A pattern having a pitch of 300 μm and a line width of 10 μm was used as the pattern of the mask. A ferric chloride solution (Baume degree: 42, temperature: 30° C.) was sprayed from a resist pattern side onto the laminate on which the resist pattern was formed to carry out etching, and then the laminate was washed. The resist was removed with an alkaline solution, and the laminate was washed and dried after removing to obtain an electromagnetic-wave shielding film (copper mesh-laminated film) having a constitution of polyethylene terephthalate film/bonding agent layer/copper mesh. The copper mesh had an aperture rate of 80% and a thickness of 10 μm.

### 2. Contrast Enhancing Film

An ionizing radiation-curable resin composition was obtained by mixing 50 parts by mass of p-cumylphenoxyethyl acrylate (brand name “NK Ester ACMP-1E”, solid concentration: 100% by mass, monofunctional, manufactured by Shin-Nakamura Chemical Co., Ltd.) and 50 parts by mass of ethylene oxide-modified bisphenol A diacrylate (brand name “NK Ester ABE-300”, solid concentration: 100% by mass, difunctional, manufactured by Shin-Nakamura Chemical Co., Ltd.) as ionizing radiation-curable components, 3 parts by mass of 1-hydroxy-cyclohexyl phenyl ketone (Irgacure 184, solid concentration: 100% by mass, manufactured by Ciba Specialty Chemicals Inc.) as a photopolymerization initiator and 0.1 part by mass of 2-acryloyloxyethylsuccinic acid (brand name “NK Ester A-SA”, solid concentration: 100% by mass, manufactured by Shin-Nakamura Chemical Co., Ltd.) as an adhesion enhancing agent.

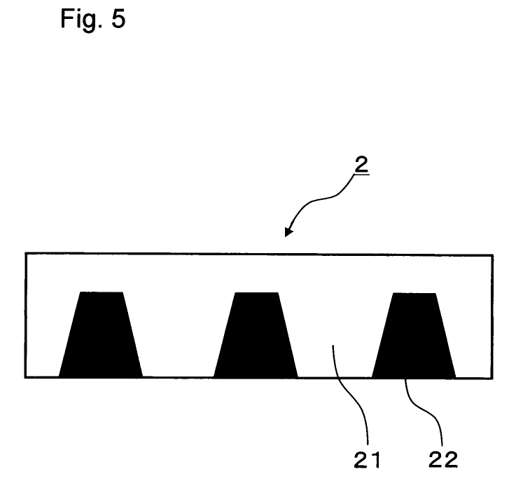

The ionizing radiation-curable resin composition thus obtained was coated on a transparent base material (brand name “Lumirror T60”, thickness: 50 μm, surface roughness (Ra): 0.001 μm, manufactured by Toray Industries, Inc.) made of polyethylene terephthalate (hereinafter referred to as the PET film) by means of a knife coater so that a film thickness (targeted film thickness) of an ionizing radiation-curable layer (semi-cured state) was 100 82 m. The ionizing radiation-curable resin composition coated staying in a state in which it was interposed between a roll die having an inversion shape formed thereon and the PET film described above was irradiated with a UV ray (a fusion H bulb used, illuminance: 400 mW/cm², luminous energy: 300 mJ/cm²), whereby a lens part 21 shown in FIG. 5 was formed.

A material prepared by dispersing carbon black as a light absorbing particle in the ionizing radiation-curable resin composition described above was filled into spaces between the lens parts 21 formed in the step described above, and black stripes were formed by irradiating with a UV ray (a fusion H bulb used, illuminance: 400 mW/cm², luminous energy: 300 mJ/cm²), whereby a contrast enhancing film 2 having the lens parts 21 and the light absorbing parts 22 each shown in FIG. 5 was completed.

In this regard, the specification of the contrast enhancing film 2 in the present example shall be shown below. The aperture rate shows a rate of an area through which light passes excluding those of the black stripes to the whole area when observing the contrast enhancing film from a light emitting layer side of plasma display (PDP), and the trapezoidal taper angle is an angle formed by a gradient part in the cross section of the trapezoid and a normal line on a boundary surface (light emitting surface) between the contrast enhancing layer and the PET film.
Aperture rate: 75%
Pitch at which the lens parts 21 were arranged: 100 μm
Refractive index of the material for the lens part 21: 1.56
Refractive index of the transparent resin: 1.55
Upper base width of the light absorbing part 22: 6 μm
Trapezoidal taper angle: 5°
Particle diameter of the light absorbing particle: 5 μm
Concentration of the light absorbing particle: 25%

### EXAMPLE 1

Seventy-seven parts by weight of butyl acrylate, 20 parts by mass of ethyl acrylate, 3 parts by mass of acrylic acid and part by mass of azobisisobutyronitrile as a polymerization initiator were added to 200 parts by mass of ethyl acetate, and the mixture was stirred at 65° C. for 17 hours to thereby obtain a solution containing an acrylic ester copolymer (Al) having a refractive index of 1.47, a specific gravity of 1.20 and a weight average molecular weight of 800,000 in a solid concentration of 29% by mass.

Then, 0.187 part by mass of organic fine particles comprising a styrene-divinylbenzene copolymer (SX-350H, manufactured by Soken Chemical & Engineering Co. Ltd., monodispersed cross-linked particles, average particle diameter: 3.5 μm, refractive index: 1.59, specific gravity: 1.05), 4 parts by mass of an aluminum chelate base cross-linking agent (M-5A, manufactured by Soken Chemical & Engineering Co. Ltd.), 30 parts by mass of methyl ethyl ketone and 5 parts by mass of toluene each based on 100 parts by mass of the acrylic ester copolymer (A1) were added in order to the solution of the acrylic ester copolymer (A1) under stirring to thereby obtain a pressure-sensitive adhesive composition for a light diffusion pressure-sensitive adhesive (LDPSA)layer. Next, the pressure-sensitive adhesive composition for a LDPSA layer described above was coated on a release-treated surface side of a polyethylene terephthalate film (trade name “SP-PET38T103-1”, manufactured by Lintec Corporation) which was a heavy peeling strength type release film by means of a knife coater. Then, the film was subjected to drying treatment at 90° C. for one minute to thereby obtain a LDPSA layer having a thickness of 25 μm on the polyethylene terephthalate film described above. Further, a light peeling strength type release film (trade name “SP-PET38 1031H (AF)”, manufactured by Lintec Corporation) of polyethylene terephthalate was covered on a naked adhesive surface of the above LDPSA layer.

Next, the light peeling strength type release film (trade name “SP-PET38 1031H (AF)”, manufactured by Lintec Corporation) described above was peeled from the LDPSA layer for an optical laminate which was covered on both surfaces with the release films, and an adhesive surface thereof was stuck on a surface reverse to a copper mesh surface of the electromagnetic-wave shielding film. Next, the heavy peeling strength type release film (trade name “SP-PET38T103-1”, manufactured by Lintec Corporation) covering the other surface of the pressure-sensitive adhesive sheet for a plasma display was peeled, and the sheet was stuck on the contrast enhancing film to thereby obtain an optical laminate having a layer constitution shown in FIG. 1. A total luminous transmittance (%) and a moire test of the optical laminate thus obtained and a haze value of the LDPSA layer were evaluated according to the methods described above. The results thereof are shown in Table 1.

### EXAMPLE 2

An optical laminate having a layer constitution shown in FIG. 1 was obtained in the same manner as in Example 1, except that a thickness of the LDPSA layer was changed to 10 μm. A total luminous transmittance (%) and a moire test of the optical laminate thus obtained and a haze value of the LDPSA layer were evaluated according to the methods described above. The results thereof are shown in Table 1.

### EXAMPLE 3

An optical laminate having a layer constitution shown in FIG. 1 was obtained in the same manner as in Example 1, except that a thickness of the diffusion pressure-sensitive adhesive layer was changed to 50 μm. A total luminous transmittance (%) and a moire test of the optical laminate thus obtained and a haze value of the LDPSA layer were evaluated according to the methods described above. The results thereof are shown in Table 1.

### EXAMPLE 4

Firstly, 68.5 parts by weight of butyl acrylate, 30 parts by mass of methyl acrylate, 1 part by mass of 2-hydroxyethyl acrylate, 0.5 part by mass of acrylamide and 0.3 part by mass of azobisisobutyronitrile as a polymerization initiator were added to 200 parts by mass of ethyl acetate, and the mixture was stirred at 65° C. for 17 hours to thereby obtain a solution containing an acrylic ester copolymer (A2) having a refractive index of 1.48, a specific gravity of 1.22 and a weight average molecular weight of 800,000 in a solid concentration of 29% by mass.

Then, 0.0435 part by mass of organic fine particles comprising a styrene-divinylbenzene copolymer (SX-350H, manufactured by Soken Chemical & Engineering Co. Ltd., monodispersed cross-linked particles, average particle diameter: 3.5 μm, refractive index: 1.59, specific gravity: 1.05), 0.45 part by mass of a xylylenediisocyanate base trifunctional adduct body (TD-75, manufactured by Soken Chemical & Engineering Co. Ltd.), 0.06 part by mass of 3-glycidoxypropyltrimethoxysilane (KBM403, manufactured by Shin-Etsu Chemical Co. Ltd.), 30 parts by mass of methyl ethyl ketone and 5 parts by mass of toluene based on 100 parts by mass of the acrylic ester copolymer (A2) were added in order to the solution of the acrylic ester copolymer (A2) under stirring to thereby obtain a pressure-sensitive adhesive composition for a LDPSA layer.

Next, the pressure-sensitive adhesive composition for a LDPSA layer described above was coated on a release-treated surface side of the polyethylene terephthalate film (trade name “SP-PET38T103-1”, manufactured by Lintec Corporation) which was a heavy peeling strength type release film by means of a knife coater. Then, the film was subjected to drying treatment at 90° C. for one minute to thereby obtain a diffusion pressure-sensitive adhesive layer having a thickness of 25 μm on the polyethylene terephthalate film described above. Further, the light peeling strength type release film (trade name “SP-PET38 1031H (AF)”, manufactured by Lintec Corporation) of polyethylene terephthalate was covered on a naked adhesive surface of the LDPSA layer described above.

Next, an optical laminate having a layer constitution shown in FIG. 1 was obtained in the same manner as in Example 1. A total luminous transmittance (%) and a moire test of the optical laminate thus obtained and a haze value of the LDPSA layer were evaluated according to the methods described above. The results thereof are shown in Table 1.

### EXAMPLE 5

The solution of the acrylic ester copolymer (A2) obtained in Example 4 was used to obtain a pressure-sensitive adhesive composition for a LDPSA layer in the same manner as in Example 4, except that an addition amount of the organic fine particles (SX-350H, manufactured by Soken Chemical & Engineering Co. Ltd.) described above was changed from 0.0435 part by mass to 0.87 part by mass.

Next, an optical laminate having a layer constitution shown in FIG. 1 was obtained in the same manner as in Example 1. A total luminous transmittance (%) and a moire test of the optical laminate thus obtained and a haze value of the LDPSA layer were evaluated according to the methods described above. The results thereof are shown in Table 1.

### EXAMPLE 6

An optical laminate of Example 6 was obtained in the same manner as in Example 1, except that a layer constitution was changed as shown in FIG. 2. A total luminous transmittance (%) and a moire test of the optical laminate thus obtained and a haze value of the LDPSA layer were evaluated according to the methods described above. The results thereof are shown in Table 1.

### EXAMPLE 7

An optical laminate of Example 7 was obtained in the same manner as in Example 1, except that a layer constitution was changed as shown in FIG. 3. A total luminous transmittance (%) and a moire test of the optical laminate thus obtained and a haze value of the LDPSA layer were evaluated according to the methods described above. The results thereof are shown in Table 1.

### COMPARATIVE EXAMPLE 1

The solution of the acrylic ester copolymer (A1) obtained in Example 1 was used to obtain a pressure-sensitive adhesive composition in the same manner as in Example 1, except that the organic fine particles (SX-350H, manufactured by Soken Chemical & Engineering Co. Ltd.) described above was not added.

Next, the pressure-sensitive adhesive composition thus obtained was used to obtain an optical laminate having a layer constitution shown in FIG. 1 in the same manner as in Example. An antiglare film (trade name “AGPET100×5”, manufactured by Lintec Corporation) was laminated on the surface of the contrast enhancing film 2 in the above laminate via the pressure-sensitive adhesive composition obtained (thickness: 25 μm) to obtain an optical laminate of Comparative Example 1 having a layer constitution shown in FIG. 4. A total luminous transmittance (%) and a moire test of the optical laminate thus obtained and a haze value of the LDPSA layer were evaluated according to the methods described above. The results thereof are shown in Table 1.

TABLE 1

| | | | | | | | | | Comparative |
|---|---|---|---|---|---|---|---|---|---|
| | | Example | | | | | | | Example |
| | | 1 | 2 | 3 | 4 | 5 | 6 | 7 | 1 |
| Constitution of optical laminate | | FIG. 1 | FIG. 1 | FIG. 1 | FIG. 1 | FIG. 1 | FIG. 2 | FIG. 3 | FIG. 4 |
| Light diffusion | Thickness of layer (μm) | 25 | 10 | 50 | 25 | 25 | 25 | 25 | 25 |
| pressure- | Haze value (%) | 19.8 | 7.8 | 38.8 | 5.4 | 53.6 | 19.8 | 19.8 | — |
| sensitive | | | | | | | | | |
| adhesive layer | | | | | | | | | |
| Evaluation | Total luminous | 82 | 85 | 69 | 86 | 65 | 82 | 82 | 81 |
| results of | transmittance (%) | | | | | | | | |
| optical laminate | Moire test result | ⊚ | ◯ | ⊚ | ◯ | ⊚ | ⊚ | ⊚ | ⊚ |

As shown in Table 1, it was found that in Examples 1, 6 and 7 in which the optical laminates obtained by using the light diffusion pressure-sensitive adhesive layer having a prescribed haze value and thickness were prepared, the same total luminous transmittance and effect for preventing a moire phenomenon as in Comparative Example 1 could be exhibited and that the optical laminates of the present invention were effective as an alternative to the optical laminate prepared in Comparative Example 1. Further, it was found that the optical laminates prepared in Examples 2 and 4 had the same total luminous transmittance as those of the optical laminates prepared in Examples 1, 6 and 7 and provided as well an effect for preventing a moire phenomenon and that the optical laminates prepared in Examples 3 and 5 were reduced in a total luminous transmittance but provided the same effect for preventing a moire phenomenon as those of the optical laminates prepared in Examples 1, 6 and 7.

### INDUSTRIAL APPLICABILITY

The optical laminate of the present invention is suitably used as an optical laminate for an optical filter in a plasma display.

What is claimed is:

1. An optical laminate used for an optical filter of a plasma display, comprising an electromagnetic-wave shielding film having a metal mesh and a contrast enhancing film, wherein a light diffusion pressure-sensitive adhesive layer containing organic fine particles is disposed on a surface of at least one of the electromagnetic-wave shielding film and the contrast enhancing film.

2. The optical laminate for a plasma display according to claim 1, wherein the light diffusion pressure-sensitive adhesive layer has a haze value of 5 to 60%.

3. The optical laminate for a plasma display according to claim 1, wherein the light diffusion pressure-sensitive adhesive layer has a thickness of 1 to 100 μm.

4. The optical laminate for a plasma display according to any of claims 1 to 3, wherein a pressure-sensitive adhesive composition constituting the light diffusion pressure-sensitive adhesive layer comprises (A) a (meth)acrylic ester base copolymer having a cross-linkable functional group in a molecule, (B) a cross-linking agent and (C) an organic fine particle in which a difference in a refractive index from that of the above (meth)acrylic ester base copolymer is 0.03 or more and which has an average particle diameter of 1 to 15 μm.

5. The optical laminate for a plasma display according to claim 4, wherein the cross-linking agent of the component (B) is a polyisocyanate compound and/or a metal chelate compound.

6. The optical laminate for a plasma display according to claim 4, wherein the pressure-sensitive adhesive composition contains 0.1 to 3.0 parts by mass of the organic fine particle of the component (C) based on 100 parts by mass of a sticky resin containing the (meth)acrylic ester base copolymer of the component (A).

7. The optical laminate for a plasma display according to of claim 4, wherein the organic fine particle of the component (C) comprises a styrene-divinylbenzene copolymer.
